(19) United States
(12) Patent Application Publication
(10) Pub. No.: US 2021/0080617 A1
(43) Pub. Date: Mar. 18, 2021

(54) ANTIREFLECTIVE FILM, DISPLAY DEVICE AND MANUFACTURING METHOD THEREOF

(71) Applicant: SHENZHEN CHINA STAR OPTOELECTRONICS TECHNOLOGY CO., LTD., Shenzhen, Guangdong (CN)

(72) Inventor: Xiangyang XU, Shenzhen, Guangdong (CN)

(21) Appl. No.: 16/080,639

(22) PCT Filed: Jun. 25, 2018
(86) PCT No.: PCT/CN2018/092596

§ 371 Date: Aug. 28, 2018

(30) Foreign Application Priority Data
Apr. 28, 2018 (CN) 201810404801.2

(51) Int. Cl. G02B 1/11; F21V 8/00

(52) U.S. Cl. CPC G02B 1/11; G02B 6/004

(57) ABSTRACT

The disclosure provides an antireflective film comprising a transparent film and light guiding particles positioned in the transparent film, and the refractive index of the light guiding particles is different from that of the transparent film, so that a diffuse reflection occurs after ambient light passing through the antireflective film. The antireflective film comprises the light guiding particles in the transparent film, because the refractive index of the light guiding particles is different from that of the transparent film, the parallel light in the environment passes through the transparent film mixed with the light guiding particles, and then the light is reflected in all directions diffusely, thereby realizing the antireflection effect of the antireflective film to ambient light, and generating a diffuse reflection effect on the display surface of the display panel. The disclosure also provides a display device and a manufacturing method thereof.

### RELATED APPLICATION

The present application claims the priority of China Application No. 201810404801.2, entitled “ANTIREFLECTIVE FILM, DISPLAY DEVICE AND MANUFACTURING METHOD THEREOF”, filed on Apr. 28, 2018, the disclosure of which is incorporated herein by reference in its entirety.

### FIELD OF THE INVENTION

The present disclosure relates to a display technology field, in particular to an antireflective film, a display device and a manufacturing method thereof.

### BACKGROUND OF THE INVENTION

With the rapid development of science and technology, people began to enter the intelligent society from the information society. From the most basic desktop computers and TVs to the widespread use of smart terminal phones, personal computers, car navigation systems and home oversized TVs, display panels are becoming an integral part of people's daily lives.

Recently, the substrate of the existing display panel is usually a glass substrate, Due to the high reflectivity of the glass to the light, under the strong lamplight and the outdoor sunlight, the glass surface of the display panel forms a specular reflection to the light source, so that the user cannot see the content displayed on the display panel clearly.

### SUMMARY OF THE INVENTION

The object of the present disclosure is to provide an antireflective film for reducing specularly reflected light on a display pane, achieving diffuse reflection to the ambient light incident on the display panel.

The disclosure also provides a display device and a manufacturing method thereof.

The antireflective film of the present disclosure comprises a transparent film and light guiding particles positioned in the transparent film, wherein the refractive index of the light guiding particles is different from that of the transparent film, so that the antireflective film realizes an antireflection function to ambient light.

The light guiding particles disclosed herein comprise a plurality of the light guiding particles having different refractive indexes, which are uniformly distributed in the transparent film.

The light guiding particles comprise a plurality of first light guiding particles and a plurality of second light guiding particles, and the size of the first light guiding particles is larger than the size of the second light guiding particles, and the first light guiding particles and the second light guiding particles are uniformly distributed in the transparent film.

The antireflective film disclosed herein comprises a first side and a second side that are oppositely disposed, and the density of the light guiding particles in the transparent film gradually increases along the direction from the first side to the second side.

The transparent film disclosed herein comprises a plurality of transparent material layers, and the light guiding particles are uniformly distributed in the transparent material layers, and at least one type of the light guiding particles is distributed in each of the transparent material layers.

The diameter of the light guiding particles disclosed herein is in a range of from 0.1 μm to 1 μm.

The thickness of the transparent film disclosed herein is in a range of from 2 μm to 4 μm.

The display device of the present disclosure comprises a display panel and an antireflective film positioned on a display surface of the display panel; and the antireflective film is the antireflective film above-mentioned.

A method for manufacturing a display device comprises:

providing a display panel;

formulating a mixed solution comprising a transparent material and light guiding particles, wherein the transparent material and the light guiding particles have different refractive indexes;

coating the mixed solution on a display surface of the display panel;

drying the display panel coated with the mixed solution.

The process of formulating a mixed solution comprising a transparent material and light guiding particles comprises: formulating a first mixed solution comprising a first transparent material and first light guiding particles, and formulating a second mixed solution comprising a second transparent material and second light guiding particles. The second mixed solution and the first mixed solution are coated sequentially on the display surface of the display panel.

The antireflective film of the present disclosure comprises the light guiding particles in the transparent film. Because the refractive index of the light guiding particles is different from that of the transparent film, when the antireflective film is covered on the display surface of the display panel, the parallel light in the environment passes through the transparent film mixed with the light guiding particles, and then the light is reflected in all directions. The antireflective film reduces specular reflection of ambient light on the display surface of the display panel, and generates a diffuse reflection effect on the display surface of the display panel; so that the user can see the display screen of the display panel clearly.

### BRIEF DESCRIPTION OF THE DRAWINGS

In order to more clearly illustrate the implementations of the present disclosure or prior art; the following figures will be described in the implementations are briefly introduced. It is obvious that the drawings are merely some implementations of the present disclosure, those of ordinary skill in this field can obtain other obvious various implementations according to these figures without paying the premise.

FIG. 1 is a schematic diagram of an antireflective film according to a first implementation of the present disclosure;

FIG. 2 is a schematic diagram of an antireflective film according to a second implementation of the present disclosure;

FIG. 3 is a schematic diagram of an antireflective film according to a third implementation of the present disclosure;

FIG. 4 is a schematic diagram of an antireflective film according to a fourth implementation of the present disclosure;

FIG. 5 is a schematic diagram of an antireflective film according to a fifth implementation of the present disclosure;

FIG. 6 is a schematic diagram of an antireflective film according to a sixth implementation of the present disclosure;

FIG. 7 is a schematic diagram of a partial structure of a display device of the present disclosure.

FIG. 8 is a flow chart showing a method for manufacturing a display device of the present disclosure.

### DETAILED DESCRIPTION OF THE INVENTION

Implementations of the present disclosure are described in detail with the technical matters, structural features, achieved objects, and effects with reference to the accompanying drawings as follows. It is clear that the described implementations are part of implementations of the present disclosure, but not all implementations. Based on the implementations of the present disclosure, all other implementations to those of ordinary skill in the premise of no creative efforts obtained should be considered within the scope of protection of the present disclosure.

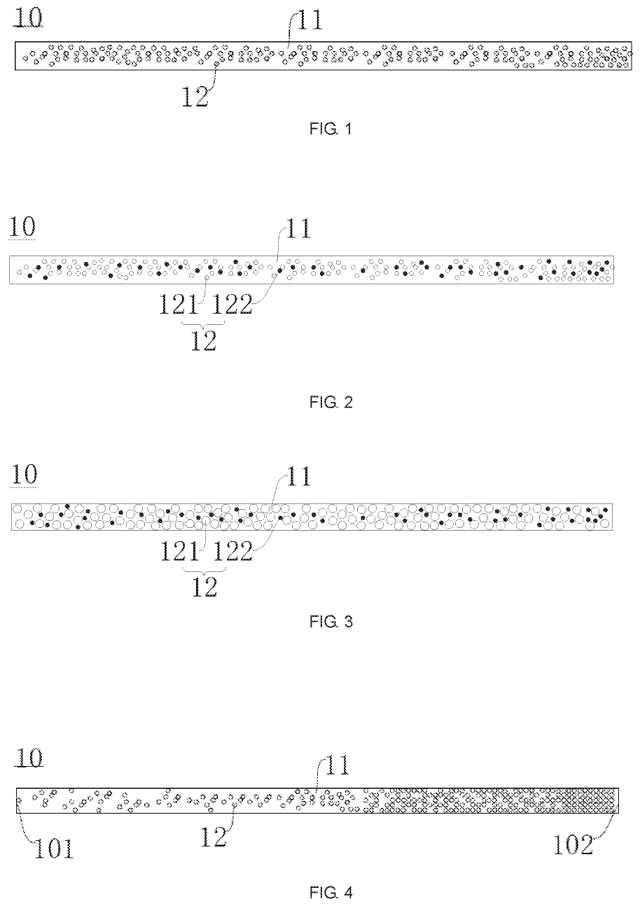

Please refer to FIG. 1, a preferred implementation of the present disclosure provides an antireflective film 10 that is generally used to cover an optical device such as a display panel to achieve an antireflection function. The antireflective film 10 comprises a transparent film 11 and light guiding particles 12 positioned in the transparent film 10, the refractive index of the light guiding particles 12 is different from that of the transparent film 11, so that the antireflective film 10 realizes the antireflection function to ambient light. In this implementation, a plurality of the light guiding particles 12 are all the same type of light guiding particles, and are made of transparent materials such as acrylic or glass.

When the antireflective film 10 of the present disclosure is covered on the display surface of the display panel, and the parallel ambient light is irradiated on the antireflective film 10, since the refractive index of the transparent film 11 in the antireflective film 10 is different from that of the light guiding particles 12 in the antireflective film 10, after the light passing through the transparent film 11 and the light guiding particles 12, the reflected light will diffusely irradiated in different directions, so that the antireflective film 10 realizes the antireflection function to ambient light, thereby causing diffuse reflection on the display surface of the display panel.

The light guiding particles 12 comprises a plurality of the light guiding particles, having different refractive indexes, which are uniformly distributed in the transparent film 11. Please refer to FIG. 2, in the second implementation of the antireflective film 10 of the present disclosure, the difference from the above implementation is that the light guiding particles 12 comprise a plurality of first light guiding particles 121 and a plurality of second light guiding particles 122. The first light guiding particles 121 are made of acryl, and the second light guiding particles 122 are made of glass, and the first light guiding particles 121 and the second light guiding particles 122 are uniformly distributed in the transparent film 11. When the antireflective film 10 is covered on the display surface of the display panel, the ambient light passes through a plurality of the light guiding particles having different refractive indexes, and then the reflected light will diffusely irradiated in different directions, so that the antireflective film 10 realizes the antireflection function to ambient light, thereby causing diffuse reflection on the display surface of the display panel. Further, the thickness of the transparent film 11 is preferably in a range of from 2 μm to 4 μm to prevent the optical device from being too thick after the antireflective film 10 is covered on the optical device. Understandably, the thickness of the transparent film 11 is larger than the size of the light guiding particles 12, and the size of the light guiding particles 12 is preferably in a range of from 0.1 μm to 1 μm to ensure optimal scattering effect of the light guiding particles 12 to ambient light. In this implementation, the plurality of light guiding particles 12 are spherical solid particles having uniformly equal diameter, and the size of the light guiding particles 12 is equal to the diameter of the spherical solid particles. The transparent film 11 is made of a transparent material such as polyimide (PI) or glass. It should be noted that the shape of the light guiding particles 12 may also be ellipsoidal or hemispherical, and the light guiding particles may also be made of other transparent materials in other implementations, as long as the refractive index of each type of the light guiding particles is different.

Please refer to FIG. 3, in the third implementation of the antireflective film 10 of the present disclosure, the difference from the second implementation is that the light guiding particles 12 comprise a plurality of first light guiding particles 121 and a plurality of second light guiding particles 122, and the size of the first light guiding particles 121 is larger than the size of the second light guiding particles 122, and the first light guiding particles 121 and the second light guiding particles 122 are uniformly distributed in the transparent film 11. When the antireflective film 10 is disposed on the display surface of the display panel, a parallel ambient light is incident on the light guiding particles 12 after passing through the transparent film 11, since the diameter of the first light guiding particles 121 is different from that of the second light guiding particles 122, the surface on which the ambient light is reflected on the light guiding particles 12 is more rough and uneven, and the reflected light is reflected randomly in different directions, resulting in diffuse reflection on the display surface of the display panel. It should be noted that specific requirements are not required for the materials of the first light guiding particles 121 and the second light guiding particles 122 in this implementation. The materials of the first light guiding particles 121 and the second light guiding particles 122 may be the same or different, as long as the refractive indexes of both the first light guiding particles 121 and the second light guiding particles 122 are different from the refractive index of the transparent film 11.

In general, the amount of light rays reaching the surface of the optical device will vary due to differences in brightness in the environment. When the antireflective film 10 is covered on the surface of the optical device, different regions of the optical device have different requirements for the antireflection effect. Please refer to FIG. 4, in the fourth implementation of the antireflective film 10 of the present disclosure, the difference from the above two implementations is that the antireflective film 10 of the present implementation is suitable for the case where the surface brightness of the optical device is inconsistent in the environment. The antireflective film 10 comprises a first side 101 and a second side 102 that are oppositely disposed, and the density of the light guiding particles 12 in the transparent film 11 gradually increases along the direction from the first side to the second side. In this implementation, taking the mobile phone display as an example, when the mobile phone display screen is affected by the environment, the vicinity of the upper short side is darker and the vicinity of the lower short side is brighter, and the display screen of the mobile phone cannot be seen clearly, then the antireflective film 10 is covered on the display surface of the mobile phone. In this case, the first side 101 is flush with the upper short side, and the second side 102 is flush with the lower short side. When the ambient light is directed toward the display panel, the antireflection effect of the antireflective film 10 to the ambient light is gradually enhanced in the direction from the first side 101 to the second side 102, so that the user can see the entire display screen of the mobile phone clearly.

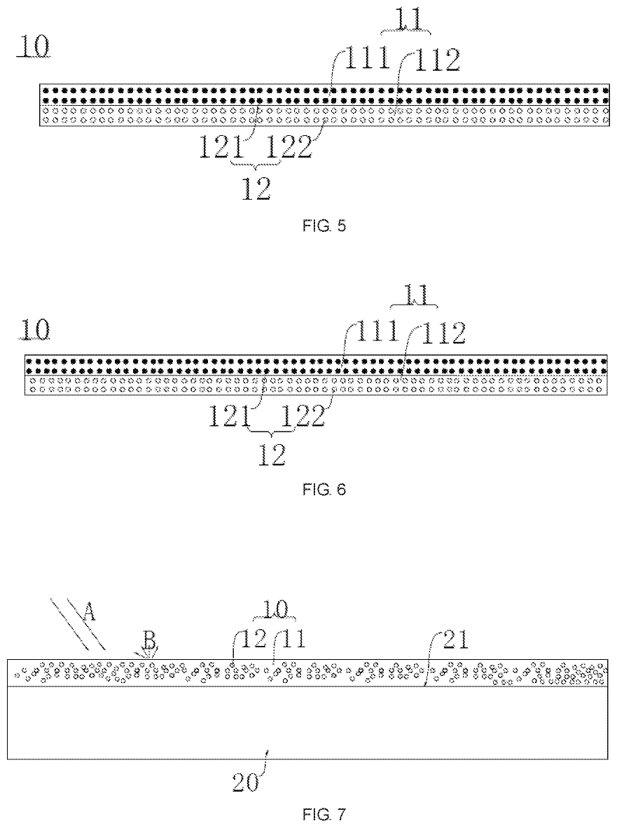

The transparent film 11 comprises a plurality of transparent material layers, and the light guiding particles 12 are uniformly distributed in the transparent material layers, and at least one type of the light guiding particles is distributed in each of the transparent material layers. Please refer to FIG. 5, in the fifth implementation of the antireflective film 10 of the present disclosure, the difference from the above three implementations is that the transparent film 11 comprises a first transparent material layer 111 and a second transparent material layer 112 stacked on the first transparent material layer 111. A plurality of the first light guiding particles 121 are distributed uniformly in the first transparent material layer 111, and a plurality of the second light guiding particles 122 are distributed uniformly in the second transparent material layer 112. In order to further enhance the antireflection function of the antireflective film 10 to ambient light, the arrangement of the light guiding particles in each of the transparent material layers can be adjusted. In this implementation, a projection of each of the first light guiding particles 121 in the second transparent material layer 112 coincides with each of the second light guiding particles 122. When the ambient light is incident on the antireflective film 10, the ambient light first passes through the first transparent material layer 111 and the first light guiding particles 121 to cause the reflected light to be diffusely irradiated in various directions The transmitted light transmitted by the first transparent material layer 111 and the first light particles 121 is incident on the second transparent material layer 112 and the second light guiding particles 122, and the reflected light of the transmitted light is also irradiated in various directions, so that the ambient light forms a diffuse reflection on the surface of optical device after passing through the antireflective film 10. It should be noted that materials of the first transparent material layer 111 and the second transparent material layer 112 are not specifically limited in this implementation. The materials of the first transparent material layer 111 and the second transparent material layer 112 may be the same or different. As long as the refractive index of the first transparent material layer 111 is different from that of the first light guiding particles 121, and the refractive index of the second transparent material layer 112 is different from that of the second light guiding particles 122, so that the antireflective film 10 can realize the antireflection function to the ambient light.

Please refer to FIG. 6, in the sixth implementation of the antireflective film 10 of the present disclosure, the difference from the fifth implementation is that a projection of each of the first light guiding particles 121 in the second transparent material layer 112 is located in the middle of the two second light guiding particles 122. When ambient light is incident on the antireflective film 10, the ambient light first passes through the first transparent material layer 111 and the first light guiding particles 121 to cause the reflected light of a portion of the ambient light to be diffusely irradiated in various directions, another portion of the ambient light is incident directly on the second transparent material layer 112 and the second light guiding particles 122 after passing through the first transparent material layer 111 from a plurality of the first light particles 121 directly. The second transparent material layer 112 and the second light guiding particles 122 make the incident light be reflected in various directions, so that the antireflective film 10 can realize the antireflection function to the ambient light that is irradiated onto the entire antireflective film 10.

Please refer to FIG. 7, the present disclosure further provides a display device, and the display device may be a touch display screen such as a mobile phone or a computer. The display device comprises a display panel 20 and an antireflective film disposed on the display surface 21 of the display panel 20. The antireflective film is one of the plurality of antireflective films 10 described above. In this implementation, the antireflective film 10 described herein is the antireflective film 10 described in the first implementation described above. The display device of the present disclosure is provided with the antireflective film 10 on the display surface 21 of the display panel 20, so that the incident light A passes through the antireflective film 10 before being incident on the display surface 21 of the display panel 20. The reflected light B diffuses from the surface of the antireflective film 10 in various directions, so that the antireflective film 10 reduces the specular reflection of the ambient light on the display surface 21, so that the user can see the display screen of the display panel 20 clearly. The display panel 20 disclosed herein is a liquid crystal display (LCD) panel or an organic light-emitting diode (OLED) panel.

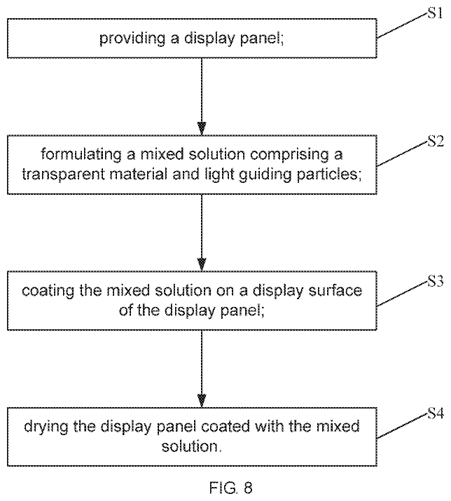

Please refer to FIG. 8, the present disclosure also provides a method for manufacturing a display device for manufacturing the above display device. The method for manufacturing the display device comprises the following steps S1 to S4. S1, a display panel 20 is provided.

S2, a mixed solution comprising a transparent material and light guiding particles 12 is formulated, wherein the transparent material and the light guiding particles 12 have different refractive indexes. In this implementation, the transparent material is an organic material. An organic solution is formulated, and then the light guiding particles 12 are mixed into the organic solution and followed by stirring uniformly to obtain a mixed solution. The light guiding particles 12 may be made of one material or a plurality of materials, and the diameters of the light guiding particles 12 may be the same or different.

S3, the mixed solution is coated on a display surface 21 of the display panel 20. Specifically, in the implementation, the mixed solution having a thickness of 2 μm to 4 μm is coated on the display surface 21 of the display panel 20 by a coating machine.

S4, the display panel 20 coated with the mixed solution is dried. Specifically, the display panel 20 coated with the mixed solution is dried at 200° C. Understandably, the drying temperature should not be too high to prevent the display panel 20 from being damaged.

The present disclosure also provides a method for manufacturing a display device, which is different from the method for manufacturing the display device described above. The method for manufacturing the display device described herein comprises the following steps.

S2, a mixed solution comprising a transparent material and light guiding particles 12 is formulated, wherein transparent material and the light guiding particles 12 have different refractive indexes. In this implementation, this step comprises: a first mixed solution comprising a first transparent material and first light guiding particles is formulated, and a second mixed solution comprising a second transparent material and second light guiding particles is formulated. Specifically, the first light guiding particles are mixed into the first organic solution and followed by stirring uniformly to obtain the first mixed solution, and the second light guiding particles are mixed into the second organic solution and followed by stirring uniformly to obtain the second mixed solution for use.

S3, the mixed solution is coated on a display surface 21 of the display panel 20. Specifically, the second mixed solution and the first mixed solution are coated sequentially on the display 21 of the display panel 20. The total thickness of the first mixed solution and the second mixed solution coated is in a range of from 2 μm to 4 μm. In this implementation, the specific thickness of the first mixed solution and the second mixed solution is not limited.

Above are implementations of the present disclosure, which does not limit the scope of the present disclosure. Any modifications, equivalent replacements or improvements within the spirit and principles of the implementation described above should be covered by the protected scope of the disclosure.

What is claimed is:

1. An antireflective film, comprising a transparent film and light guiding particles positioned in the transparent film, wherein the refractive index of the light guiding particles is different from that of the transparent film, so that the antireflective film realizes an antireflection function to ambient light.

2. The antireflective film according to claim 1, wherein the light guiding particles comprise a plurality of the light guiding particles having different refractive indexes, which are uniformly distributed in the transparent film.

3. The antireflective film according to claim 1, wherein the size of the light guiding particles is in a range of from 0.1 μm to 1 μm.

4. The antireflective film according to claim 2, wherein the size of the light guiding particles is in a range of from 0.1 μm to 1 μm.

5. The antireflective film according to claim 1, wherein the light guiding particles comprise a plurality of first light guiding particles and a plurality of second light guiding particles, and the size of the first light guiding particles is larger than the size of the second light guiding particles, and the first light guiding particles and the second light guiding particles are uniformly distributed in the transparent film.

6. The antireflective film according to claim 5, wherein the size of the light guiding particles is in a range of from 0.1 μm to 1 μm.

7. The antireflective film according to claim 1, wherein the antireflective film comprises a first side and a second side that are oppositely disposed, and the density of the light guiding particles in the transparent film gradually increases along the direction from the first side to the second side.

8. The antireflective film according to claim 7, wherein the size of the light guiding particles is in a range of from 0.1 μm to 1 μm.

9. The antireflective film according to claim 1, wherein the transparent film comprises a plurality of transparent material layers, and the light guiding particles are uniformly distributed in the transparent material layers, and at least one type of the light guiding particles is distributed in each of the transparent material layers.

10. The antireflective film according to claim 9, wherein the size of the light guiding particles is in a range of from 0.1 μm to 1 μm.

11. The antireflective film according to claim 3, wherein the thickness of the transparent film is in a range of from 2 μm to 4 μm.

12. A display device comprising a display panel and an antireflective film according to claim 1, the antireflective film being positioned on a display surface of the display panel.

13. The display device according to claim 12, wherein the light guiding particles comprise a plurality of the light guiding particles having different refractive indexes, which are uniformly distributed in the transparent film.

14. The display device according to claim 12, wherein the light guiding particles comprise a plurality of first light guiding particles and a plurality of second light guiding particles, and the size of the first light guiding particles is larger than the size of the second light guiding particles, and the first light guiding particles and the second light guiding particles are uniformly distributed in the transparent film.

15. The display device according to claim 12, wherein the antireflective film comprises a first side and a second side that are oppositely disposed, and the density of the light guiding particles in the transparent film gradually increases along the direction from the first side to the second side.

16. The display device according to claim 12, wherein the transparent film comprises a plurality of transparent material layers, and the light guiding particles are uniformly distributed in the transparent material layers, and at least one type of the light guiding particles is distributed in each of the transparent material layers.

17. The display device according to claim 12, wherein the size of the light guiding particles is in a range of from 0.1 μm to 1 μm.

18. The display device according to claim 17, wherein the thickness of the transparent film is in a range of from 2 μm to 4 μm.

19. A method for manufacturing a display device comprises;
providing a display panel;
formulating a mixed solution comprising a transparent material and light guiding particles, wherein the transparent material and the light guiding particles have different refractive indexes;
coating the mixed solution on a display surface of the display panel;
drying the display panel coated with the mixed solution.

20. The method for manufacturing a display device according to claim 19, wherein the process of formulating a mixed solution comprising a transparent material and light guiding particles comprises:
formulating a first mixed solution comprising a first transparent material and first light guiding particles and formulating a second mixed solution comprising a second transparent material and second light guiding particles;
and wherein the second mixed solution and the first mixed solution are coated sequentially on the display surface of the display panel.
